(19) United States
(12) Patent Application Publication
(10) Pub. No.: US 2018/0290503 A1
(43) Pub. Date: Oct. 11, 2018

(54) CONSTRUCTION VEHICLE TIRE

(71) Applicant: BRIDGESTONE CORPORATION, Tokyo (JP)

(72) Inventor: Atsushi KITORA, Tokyo (JP)

(73) Assignee: BRIDGESTONE CORPORATION, Tokyo (JP)

(21) Appl. No.: 15/764,719

(22) PCT Filed: Sep. 30, 2016
(86) PCT No.: PCT/JP2016/079078

§ 371 Date: Mar. 29, 2018

(30) Foreign Application Priority Data
Oct. 2, 2015 (JP) 2015-196705
Sep. 23, 2016 (JP) 2016-185614

(51) Int. Cl. B60C 15/00

(52) U.S. Cl. CPC B60C 15/0054; B60C 2200/065

(57) ABSTRACT

To provide a construction vehicle tire capable of reducing compression strain generated in a carcass folded portion and improving durability of a bead portion even in a state closer to an actual use environment in which large lateral force is input. In a construction vehicle tire (1) according to the present invention, when mounted to a wheel rim (100), a height (HA) of a carcass cord (31) of a carcass body (40) corresponding to the minimum value a from a base line (BL) of the wheel rim (100), a height (HB) of the carcass cord (31) of the carcass body portion (40) corresponding to the maximum value b from the base line (BL), and a flange height (HF) of the wheel rim (100) from the base line (BL) fulfill relations of 1.2 HF≤HA≤2.5 HF, 2.6 HF≤HB≤3.5 HF, and 1.10≤b/a<1.40.

### TECHNICAL FIELD

The present invention relates to a construction vehicle tire, in particular, a construction vehicle tire in which durability of a bead portion is improved.

### BACKGROUND ART

A large load is applied to a construction vehicle tire mounted to a construction vehicle that travels on an uneven road surface in a construction site and has a large loading mount, and therefore it is especially important to improve durability of a bead portion in order to lengthen a tire life.

In the construction tire used in the environment described above, a large compression strain is repeatedly generated in a carcass folded portion folded at a bead core from a carcass body portion toward an outer side in a tire radial direction, and therefore a method for reducing the compression strain is proposed. For example, a method for optimizing a distance between the carcass body portion and the carcass folded portion, specifically a distance between carcass cords in a section along a tire width direction (distance between cords), in accordance with a height position from the bead portion is known (see Patent Literature 1).

More specifically, it is proposed that the distance between the cords is set to be the minimum near the bead core, and then the distance is increased toward the outer side in the tire radial direction and is set to be the maximum at a predetermined height position from the bead portion.

### CITATION LIST

### Patent Literature

[PTL 1] Japanese Unexamined Patent Application Publication No. 2009-113715 (pages 5 to 7 and FIG. 4)

### SUMMARY OF INVENTION

According to the conventional construction vehicle tire described above, the compression strain generated in the carcass folded portion due to vertical force (Fz) can be reduced, however in an actual use environment, the compression strain is also generated in the carcass folded portion due to lateral force (Fy). That is, an inflection point of the carcass folded portion with respect to the compression strain in a state in which the lateral force is large is shifted from an inflection point of the carcass folded portion in a state in which the lateral force is small, and thereby it is found that the compression strain might not be always reduced effectively.

Specifically, in a state in which the lateral force is large, a position of the inflection point is moved toward an end portion of the carcass folded portion at the outer side in the tire radial direction, and therefore the compression strain might not be reduce effectively in a positional relation between the carcass body portion and the carcass folded portion in the conventional construction vehicle tire described above.

Accordingly, an object of the present invention is, in consideration of the problem described above, to provide a construction vehicle tire capable of reducing compression strain generated in a carcass folded portion even in a state closer to an actual use environment in which large lateral force is input, and capable of improving durability of a bead portion.

A first feature of the present invention is that, in a construction vehicle tire (construction vehicle tire 1) including a carcass body portion (carcass body portion 40) formed by a covered carcass cord (carcass cord 31), and a carcass folded portion (carcass folded portion 50) continued to the carcass body portion and folded at a bead core (bead core 61) from an inner side in a tire width direction toward an outer side in the tire width direction, the carcass folded portion being formed by a covered carcass cord, a distance between cords, which is defined by a distance between the carcass cord of the carcass body portion and the carcass cord of the carcass folded portion, becomes smaller from the bead core toward an outer side in a tire radial direction to a minimum value a, and after the distance between the cords becomes the minimum value a, the distance between the cords becomes larger toward the outer side in the tire radial direction to the maximum value b, and when the construction vehicle tire is mounted to an applicable rim (wheel rim 100), a height HA of the carcass cord of the carcass body portion corresponding to the minimum value a from a base line of the applicable rim, a height HB of the carcass cord of the carcass body portion corresponding to the maximum value b from the base line of the applicable rim, and a flange height HF of the applicable rim from the base line of the applicable rim fulfill relations of 1.2 HF≤HA≤2.5 HF, and 3.1 HF≤HB≤4.5 HF.

In the first feature of the present invention, a distance L1 along the carcass cord of the carcass folded portion between a position of the minimum value a and a position of the maximum value b may be longer than a distance L2 along the carcass cord of the carcass folded portion between the position of the maximum value b and an end portion (end portion 51) at the outer side in the tire radial direction of the carcass folded portion.

In the first feature of the present invention, the number of the portions of the maximum value b may be only one between the bead core and the end portion at the outer side in the tire radial direction of the carcass folded portion.

In the first feature of the present invention, a ratio b/a of the minimum value a and the maximum value b may be equal to or more than 1.10 and less than 2.00.

A second feature of the present invention is that, in a construction vehicle tire (construction vehicle tire 1) including a carcass body portion (carcass body portion 40) formed by a covered carcass cord (carcass cord 31), and a carcass folded portion (carcass folded portion 50) continued to the carcass body portion and folded at a bead core (bead core 61) from an inner side in a tire width direction toward an outer side in the tire width direction, the carcass folded portion being formed by a covered carcass cord, a distance between cords, which is defined by a distance between the carcass cord of the carcass body portion and the carcass cord of the carcass folded portion, becomes smaller from the bead core toward an outer side in a tire radial direction to a minimum value a, and after the distance between the cords becomes the minimum value a, the distance between the cords becomes larger toward the outer side in the tire radial direction to the maximum value b, and when the construction vehicle tire is mounted to an applicable rim (wheel rim 100), a height HA of the carcass cord of the carcass body portion corresponding to the minimum value a from a base line of the applicable rim, a height HB of the carcass cord of the carcass body portion corresponding to the maximum value b from the base line of the applicable rim, and a flange height HF of the applicable rim from the base line of the applicable rim fulfill relations of 1.2 HF≤HA≤2.5 HF, 2.6 HF≤HB≤3.5 HF, and 1.10≤b/a<1.40.

In the second feature of the present invention, a height CH of a carcass line of a tread portion of the construction vehicle tire from the base line of the applicable rim and a height PE of an end portion of the carcass folded portion from the base line of the applicable rim may fulfill a relation of 0.50≤PE/CH≤0.58.

In the second feature of the present invention, a crossing angle θ between a straight line SL1 passing a position of the carcass cord of the carcass body portion corresponding to the minimum value a and a position of the carcass cord of the carcass body portion corresponding to the maximum value b, and a straight line SL2 passing a position of the carcass cord of the carcass folded portion corresponding to the minimum value a and a position of the carcass cord of the carcass folded portion corresponding to the maximum value b may fulfill a relation of 2.00°≤θ≤5.00°.

In the second feature of the present invention, the number of the portions of the maximum value b may be only one between the bead core and the end portion at the outer side in the tire radial direction of the carcass folded portion.

### BRIEF DESCRIPTION OF DRAWINGS

FIG. 1 is a cross-sectional view along a tire width direction and a tire radial direction illustrating a part of a construction vehicle tire 1.

FIG. 2 is an enlarged cross-sectional view illustrating a bead portion 60 of the construction vehicle tire 1.

FIG. 3 is a view illustrating a specific positional relation between a carcass body portion 40 and a carcass folded portion 50 of the construction vehicle tire 1.

FIG. 4 is a view illustrating a specific shape of the carcass folded portion 50 of the construction vehicle tire 1.

FIG. 5 is an enlarged cross-sectional view of a bead portion 60 of a construction vehicle tire 1A.

FIG. 6 is a view illustrating a specific positional relation between a carcass body portion 40 and a carcass folded portion 50 of the construction vehicle tire 1A.

FIG. 7 is a schematic view for describing a compression deformation and a tensile deformation generated in the construction vehicle tire 1.

FIG. 8 is a graph illustrating a test result of construction vehicle tires according to a conventional example, a comparative example and examples.

### DESCRIPTION OF EMBODIMENTS

### First Embodiment

At first, a construction vehicle tire according to a first embodiment of the present invention will be described with reference to drawings.

### (1) Schematic Configuration of Construction Vehicle Tire

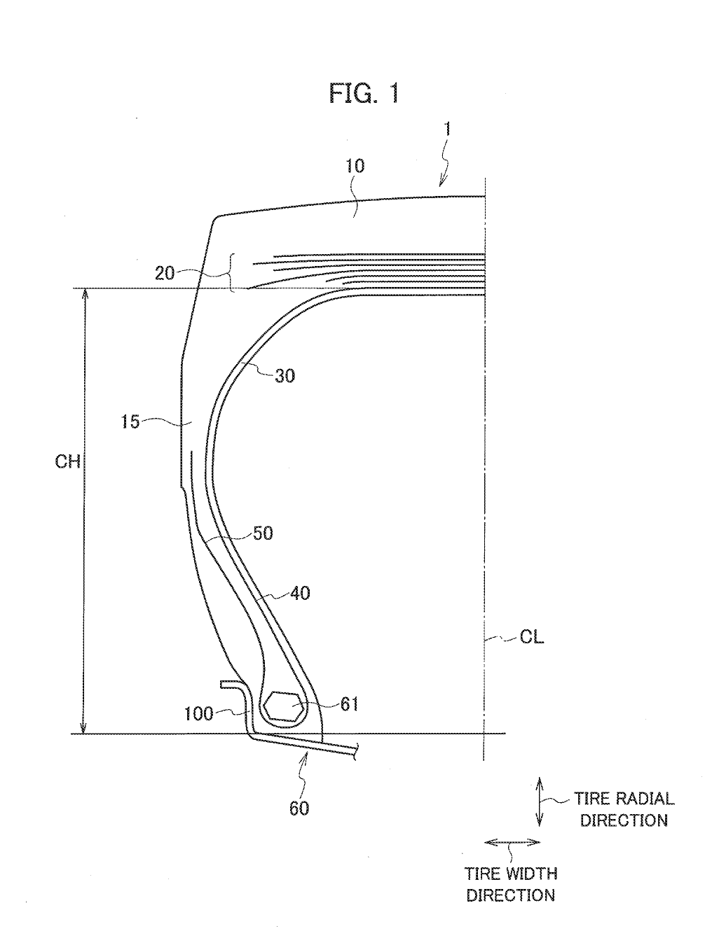

FIG. 1 is a cross-sectional view along a tire width direction and a tire radial direction illustrating a part of a construction vehicle tire 1 according to the present embodiment. The construction vehicle tire 1 is formed symmetry in a lateral direction with respect to a tire equatorial line CL.

The construction vehicle tire 1 is preferably used as a construction vehicle tire used in, for example, a dump truck, an articulate dump truck, or a wheel loader that travels on crushed stones, or in a mine or a dam construction site. As shown in FIG. 1, the construction vehicle tire 1 is provided with a tread portion 10 that contacts with a road surface, a side wall portion 15 continued to the tread portion 10 and arranged at an inner side in the tire radial direction with respect to the tread portion 10, and a bead portion 60 continued to the side wall portion 15 and arranged at the inner side in the tire radial direction with respect to the side wall portion 15.

A belt layer 20 formed by a plurality of belts (for example, 4 to 6 sheets) with a cord is arranged at the inner side in the tire radial direction of the tread portion 10. Further, a pattern (not shown) in accordance with a use environment of the construction vehicle tire 1 or a kind of a construction vehicle to which the construction vehicle tire 1 is mounted is formed in the tread portion 10.

Further, a carcass layer 30 that forms a frame of the construction vehicle tire 1 is arranged at the inner side in the tire radial direction of the belt layer 20 between a pair of right and left bead cores 61.

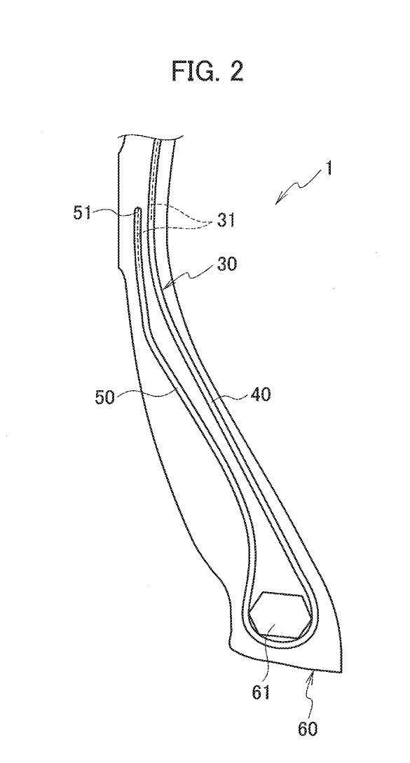

In the present embodiment, the carcass layer 30 is formed as a radial structure having a carcass cord 31 (not shown in FIG. 1, see FIG. 2) radially arranged along the tire radial direction. However, it is not limited to the radial structure, and therefore a bias structure in which the carcass cord is arranged to cross the tire radial direction may be adopted.

Further, as shown in FIG. 1, the construction vehicle tire 1 is formed as a pneumatic tire. The gas filled into the construction vehicle tire 1 mounted to a wheel rim 100 is not limited to air, and therefore an inert gas such as a nitrogen gas may be filled. Further, a liquid for cooling (coolant) may be filled.

### (2) Configuration of Bead Portion

FIG. 2 is an enlarged cross-sectional view illustrating the bead portion 60 of the construction vehicle tire 1. As shown in FIG. 2, the carcass layer 30 is formed by a carcass body portion 40 and a carcass folded portion 50. Each of the carcass body portion 40 and the carcass folded portion 50 has a structure in which the carcass cord 31 is covered with rubber.

The carcass body portion 40 is located at a portion from the tread portion 10 (see FIG. 1) to a bead core 61 so as to form a body portion of the carcass layer 30. The carcass folded portion 50 is continued to the carcass body portion 40 and folded at the bead core 61 from an inner side in the tire width direction toward an outer side in the tire width direction. The carcass folded portion 50 is extended from the bead core 61 toward the outer side in the tire radial direction. An end portion 51 of the carcass folded portion 50 terminates in the side wall portion 15.

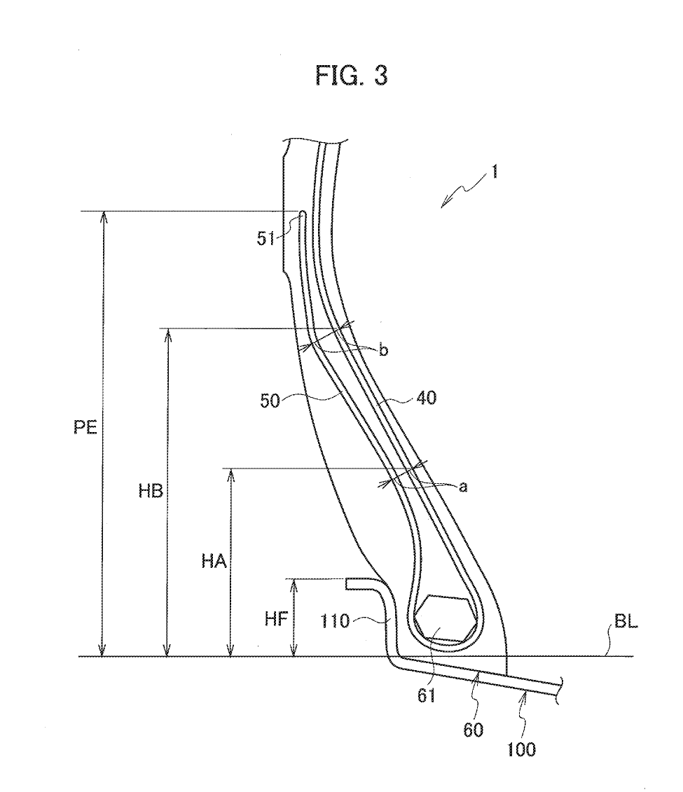

FIG. 3 shows a specific positional relation between the carcass body portion 40 and the carcass folded portion 50 of the construction vehicle tire 1. As shown in FIG. 3, a distance between cords, which is defined by a distance between the carcass cord 31 of the carcass body portion 40 and the carcass cord 31 of the carcass folded portion 50, becomes smaller from the bead core 61 toward the outer side in the tire radial direction to a minimum value a. After becoming the minimum value a, the distance between the cords becomes larger toward the outer side in the tire radial direction to a maximum value b.

Further, the distance between the cords is defined by a distance (gap), in a section along the tire width direction and the tire radial direction as shown in FIG. 2, between the carcass cord 31 of the carcass body portion 40 and the carcass cord 31 of the carcass folded portion 50 with respect to a tangent line of the carcass cord 31 of the carcass body portion 40 as a reference. More specifically, the distance between the cords is defined by a distance between a center in a thickness direction of the carcass cord 31 of the carcass body portion 40 and a center in a thickness direction of the carcass cord 31 of the carcass folded portion 50.

When the construction vehicle tire 1 is mounted to the wheel rim 100 as an applicable rim, a height HA of the carcass cord 31 of the carcass body portion 40 corresponding to the minimum value a from a base line BL of the wheel rim 100, a height HB of the carcass cord 31 of the carcass body portion 40 corresponding to the maximum value b from the base line BL, and a height HF of a rim flange 110 of the wheel rim 100 from the base line BL fulfill the following relations.

1.2HF≤HA≤2.5HF

3.1HF≤HB≤4.5HF

Here, the base line BL is a straight line parallel to a rotation axis of the wheel rim 100 and passing an end portion (bead heel) at the outer side in the tire radial direction of the bead portion 60.

Further, the applicable rim is, for example, a wheel rim having a standard size defined in Year Book of Japan Automobile Tyre Manufacturers Association (JATMA), and the heights HA, HB, HF are measured in a state in which measurement conditions (mounting to the applicable rim, setting of defined inner pressure, setting temperature or the like) defined in JATMA are fulfilled. Here, other standard (TRA, ETRTO or the like) may be adopted instead of JATMA.

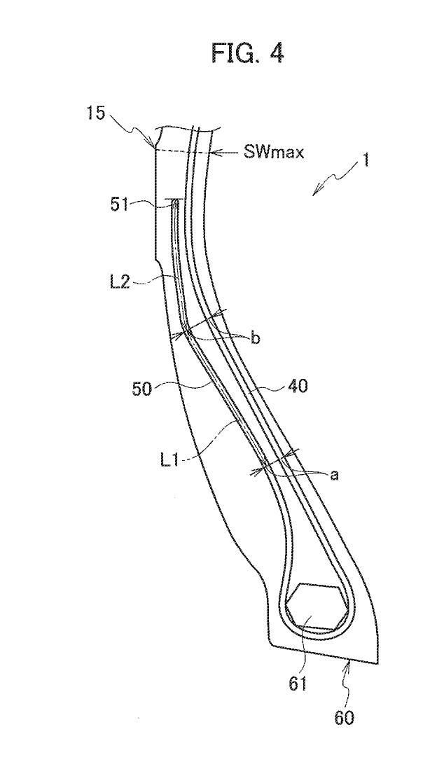

FIG. 4 shows a specific shape of the carcass folded portion 50 of the construction vehicle tire 1. As shown in FIG. 4, a distance along the carcass cord 31 of the carcass folded portion 50 between a position of the minimum value a and a position of the maximum value b is defined as a distance L1. Further, a distance along the carcass cord 31 of the carcass folded portion 50 between the position of the maximum value b and the end portion 51 at the outer side in the tire radial direction of the carcass folded portion 50 is defined as a distance L2.

In the construction vehicle tire 1, the distance L1 is longer than the distance L2. That is, in the positional relation between the minimum value a, the maximum value b and the end portion 51 of the carcass folded portion 50 in the tire radial direction, a portion of the maximum value b is located at the outer side in the tire radial direction compared to that in a conventional example (described below).

The end portion 51 of the carcass folded portion 50 terminates near a position of a maximum width SWmax in which a width of the side wall portion 15 in the tire width direction is the maximum. Further, it is preferable that the end portion 51 terminates at the inner side in the tire radial direction with respect to the portion of the maximum width SWmax. Accordingly, a position in the tire radial direction of the maximum value b is also located at the inner side in the tire radial direction with respect to the portion of the maximum width SWmax. Or alternatively, it is preferable that the position in the tire radial direction of the maximum value b is located at the outer side in the tire radial direction with respect to a position of a half of a height from the base line BL (see FIG. 3) to the portion of the maximum width SWmax.

Further, in a thickness relation in a rubber gage in the position of the maximum value b, a thickness between a tire surface and an outer side surface in the tire width direction of the carcass folded portion 50 is thinner than a thickness between an inner side surface in the tire width direction of the carcass folded portion 50 and an outer side surface in the tire width direction of the carcass body portion 40. On the other hand, a thickness relation in the rubber gage in the position of the minimum value a is opposite to the thickness relation in the position of the maximum value b, and therefore a thickness between the tire surface and the outer side surface of the tire width direction of the carcass folded portion 50 is thicker than a thickness between the inner side surface in the tire width direction of the carcass folded portion and the outer side surface in the tire width direction of the carcass body portion 40.s

In the present embodiment, the number of the portions of the maximum value b is only one between the bead core 61 and the end portion 51 of the carcass folded portion 50. However, the number of the portions of the maximum value b is not necessarily one. Further, in the present embodiment, a ratio b/a of the minimum value a and the maximum value b is equal to or more than 1.10 and less than 2.00.

### Second Embodiment

Next, a second embodiment of the present invention will be described. Hereinafter, a difference from the construction vehicle tire 1 according to the first embodiment described above will be mainly described, and therefore a description of a configuration similar to that in the construction vehicle tire 1 will be omitted as needed.

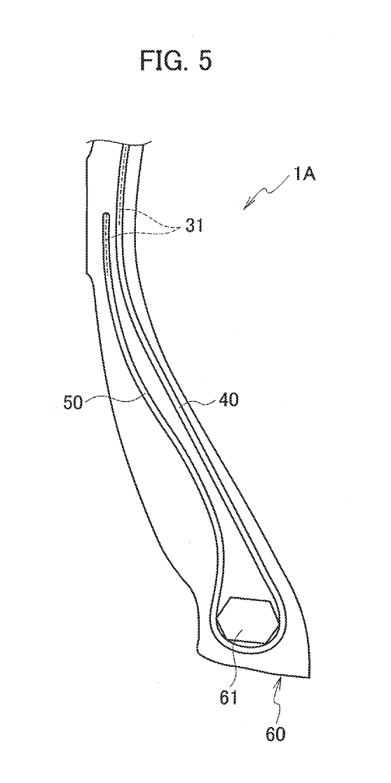

FIG. 5 is an enlarged cross-sectional view of a bead portion 60 of a construction vehicle tire 1A according to the present embodiment. Each configuration of a tread portion 10 and a belt layer 20 of the construction vehicle tire 1A is similar to that of the construction vehicle tire 1. As shown in FIG. 5, in the construction vehicle tire 1A, a shape (positional relation) of a carcass folded portion 50 is different from that in the construction vehicle tire 1.

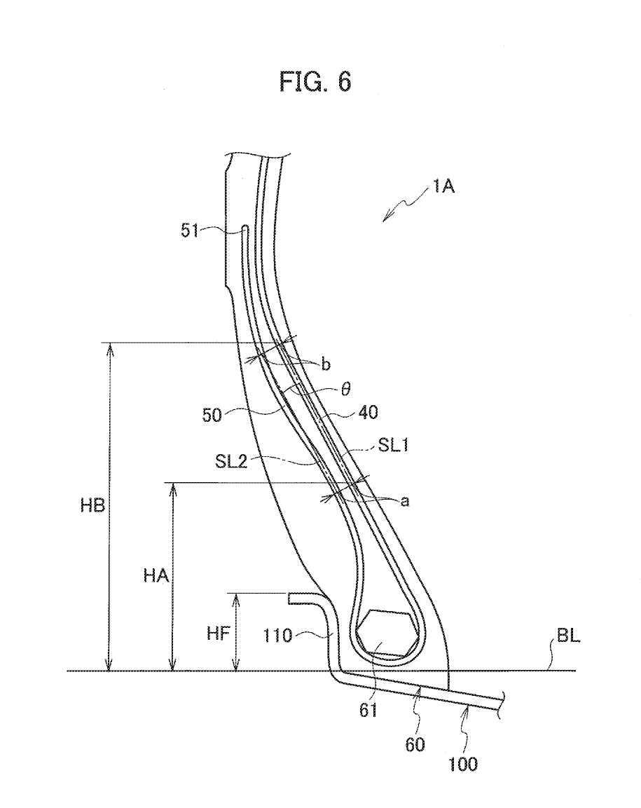

FIG. 6 shows a specific positional relation of a carcass body portion 40 and the carcass folded portion 50 of the construction vehicle tire 1A. As shown in FIG. 6, when the construction vehicle tire 1A is mounted to a wheel rim 100, a height HA of the carcass cord 31 of the carcass body portion 40 corresponding to the minimum value a from a base line BL of the wheel rim 100, a height HB of the carcass cord 31 of the carcass body portion 40 corresponding to the maximum value b from the base line BL, and a height HF of a rim flange 110 of the wheel rim 100 from the base line BL fulfill the following relations.

1.2HF≤HA≤2.5HF

2.6HF≤HB≤3.5HF

1.10≤b/a<1.40

Further, a crossing angle θ between a straight line SL1 passing a position of the carcass cord 31 of the carcass body portion 40 corresponding to the minimum value a and a position of the carcass cord 31 of the carcass body portion 40 corresponding to the maximum value b, and a straight line SL2 passing a position of the carcass cord 31 of the carcass folded portion 50 corresponding to the minimum value a and a position of the carcass cord 31 of the carcass folded portion 50 corresponding to the maximum value b fulfills the following relation.

2.00°≤θ≤5.00°

In this way, the crossing angle θ is small, and therefore in the construction vehicle tire 1A, the maximum value b of the distance between the cords is small compared to the conventional example and the construction vehicle tire 1.

Here, similar to the construction vehicle tire 1 according to the first embodiment, the number of the portions of the maximum value b is only one between the bead core 61 and the end portion 51 of the carcass folded portion 50. However, the number of the portions of the maximum value b is not necessarily one.

Further, in the construction vehicle tire 1A, it is preferable that a height CH (case height) of a carcass line of the tread portion 10 of the construction vehicle tire 1A from the base line BL and a height PE (carcass folded portion height) of the end portion 51 of the carcass folded portion 50 from the base line BL fulfill the following relation.

0.50≤PE/CH≤0.58

Here, the carcass line of the tread portion 10 denotes a straight line passing an outer edge in the tire radial direction of the carcass layer 30 (carcass body portion 40) and parallel to the tire width direction.

### Functions and Effects

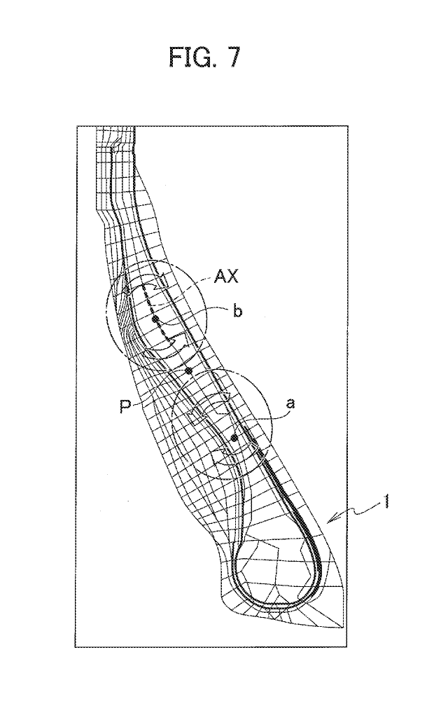

FIG. 7 is a schematic view for describing a compression deformation and a tensile deformation generated in the construction vehicle tire 1. As shown in FIG. 7, when a load is applied to the construction vehicle tire 1, the compression deformation is generated in the carcass folded portion 50 near the portion in which the distance between the cords becomes the minimum value a. On the other hand, the tensile deformation is generated in the carcass folded portion 50 near the portion in which the distance between the cords becomes the maximum value b.

The carcass cord 31 of the carcass folded portion 50 gradually extends to the outer side in the tire width direction from the position of the minimum value a toward the position of the maximum value b. That is, the carcass cord 31 of the carcass folded portion 50 gradually goes away from the carcass cord 31 of the carcass body portion 40. Thus, even if the compression deformation is generated in the carcass cord 31 of the carcass body portion 40, buckling of the carcass folded portion 50, more specifically meandering of the carcass cord 31 of the carcass folded portion 50 being bent due to the compression deformation, can be suppressed.

The distance between the cords is ensured sufficiently near the position of the maximum value b, and therefore the position of the carcass cord 31 of the carcass folded portion 50 is sufficiently separated from a neutral axis AX of bending near the position of the maximum value b. Thus, the carcass folded portion 50 can be further adapted to the tensile deformation and the tensile deformation near the position of the maximum value b is expanded. As a result, the compression deformation near the position of the minimum value a can be also suppressed.

Further, in the construction vehicle tire 1, the maximum value b is located at the outer side in the tire radial direction compared to the conventional example, and thereby in a case in which the tensile deformation or the compression deformation is generated in the construction vehicle tire 1, especially even in a state in which the lateral force (Fy) is large, it can be firmly avoided that an inflection point P between the tensile deformation and the compression deformation is located at the outer side in the tire radial direction with respect to the position of the maximum value b (reverse phenomenon).

Such an effect is similarly obtained in the construction vehicle tire 1A in which the maximum value b of the distance between the cords is set to be small. In the construction vehicle tire 1A, a degree of adaption to the tensile deformation is restricted compared to the construction vehicle tire 1, however by setting the maximum value b to be small, dispersion of the structural rigidity is less and shift of the inflection point P is less, and thereby the reverse phenomenon described above can be suppressed.

Further, in the construction vehicle tire 1A, in a case in which the CH (case height) and the PE (carcass folded portion height) fulfill the relation of 0.50≤PE/CH≤0.58, the distance between the cords becomes larger to the maximum value b after becoming the minimum value a toward the outer side in the tire radial direction, and in a case in which the heights HA, HB of the carcass cords 31, the height HF of the rim flange 110 of the wheel rim 100 from the base line BL fulfill the relations described above, separation in an end portion of the belt layer 20, so-called ply end separation (PES), can be suppressed effectively.

Specifically, when the lateral force (Fy) is input into the construction vehicle tire 1A, the construction tire 1A is deformed as a whole, and therefore in a structure in which the distance between the cords becomes larger to the maximum value b after becoming the minimum value a toward the outer side in the tire radial direction, the ply end separation might be led depending on a position of the end portion 51 of the carcass folded portion 50.

Accordingly, by setting the relation between the CH (case height) and the PE (carcass folded portion height) to be in a range of 0.50≤PE/CH≤0.58, an appropriate distance between the end portion 51 and the belt layer 20 can be ensured while reducing the compression strain generated in the carcass folded portion 50, and therefore the ply end separation can be effectively suppressed. Here, in a case in which the relation between the CH (case height) and the PE (carcass folded portion height) is out of the range described above, the effect of the suppression of the ply end separation (PES) or the reduction of the compression strain generated in the carcass folded portion 50 is restrictive.

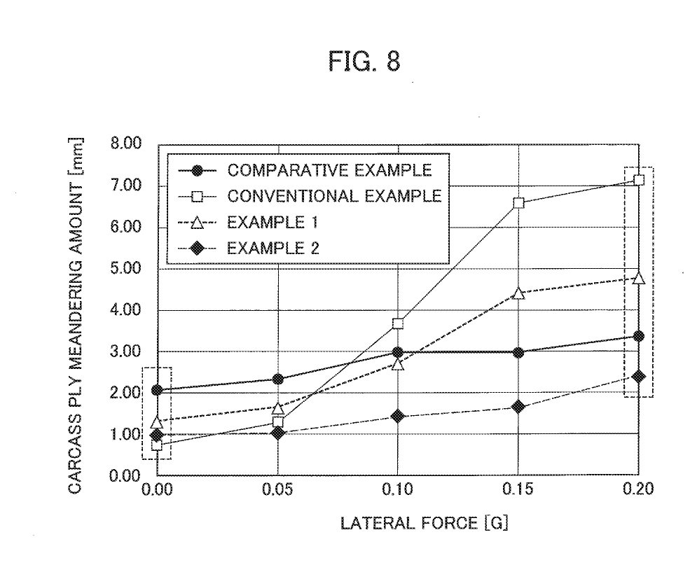

FIG. 8 shows a test result of construction vehicle tires according to the conventional example, a comparative example, and examples (example 1, and example 2). The conventional example shown in FIG. 8 is formed as a construction vehicle tire disclosed in a prior art (JP 2009-113715 A). The comparative example is formed as a construction vehicle tire without a portion having a convex shape such as the portion of the maximum value b in the carcass folded portion 50. The example 1 is formed as the construction vehicle tire 1, and the example 2 is formed as the construction vehicle tire 1A. Further, an example 3 is formed as the construction vehicle tire 1A in which the CH (case height) and the PE (carcass folded portion height) fulfill the relation described above. A basic configuration of the example 3 is similar to that of the example 2.

Specifically, the example 1 has the following setting values.

HA=2.06 HF

HB=3.55 HF

b/a=1.34

The example 2 has the following setting values.

HA=2.06 HF

HB=3.00 HF

b/a=1.34

θ=4°

The example 3 further has the following setting value.

PE/CH=0.56

Here, a size of each of the construction vehicle tires used in the test is 59/80R63.

As shown in FIG. 8, in the construction vehicle tires according to the conventional example, and the examples 1, 2, in a state in which the lateral force (Fy) is not input and the vertical force (Fz) is only input (lateral force=0.00G), a meandering amount (buckling) of the carcass layer (ply) is suppressed at a low level. On the other hand, in the comparative example, in a state in which the vertical force (Fz) is only input, the meandering amount is relatively large. Here, the vertical force (Fz) is set to 120 t.

As the lateral force is increased, the meandering amount is increased in the conventional example. That is, the carcass layer is not sufficiently adapted to the compression deformation. On the other hand, in the comparative example, and the examples 1, 2 (especially, the example 2), even when the lateral force is increased, the meandering amount is not extremely increased, and therefore those tires can be adapted to the actual use environment.

In this way, according to the construction vehicle tire 1 according to the first embodiment (example 1) and the construction vehicle tire 1A according to the second embodiment (example 2), the minimum value a and the maximum value b of the distance between the cords, HA, HB, HF, b/a, and θ (in a case of the example 2) fulfill the relations described above. With this, in a state closer to the actual environment in which the large lateral force is input, the compression strain generated in the carcass folded portion 50 can be reduced, and the durability of the bead portion 60 can be improved.

Here, in a case in which HA, HB, HF, b/a, and θ do not fulfill the relations described above, the characteristics of the example 1 and the example 2 shown in FIG. 8 are not obtained, and therefore the improvement of the durability of the bead portion 60 is restrictive.

Further, as shown in FIG. 8, according to the construction vehicle tire 1 and the construction vehicle tire 1A, in a state in which the vertical force (Fz) is only input, the meandering amount (buckling) of the carcass layer (ply) is suppressed at a low level, and therefore any adverse influence is not exerted to the durability of the bead portion 60.

Further, in a case of the example 3, it is found that the ply end separation (PES) is reduced by approximately 20% compared to the example 1 and the example 2 in an evaluation test. Specifically, in a case in which PE/CH is less than 0.50 and in a case in which PE/CH is more than 0.58, the ply end separation tends to increase.

That is, when PE/CH fulfills the relation of 0.50≤PE/CH≤0.58, the ply end separation (PES) can be also suppressed effectively.

### OTHER EMBODIMENTS

As described above, although the content of the present invention was disclosed through the embodiments of the present invention, the embodiments of the present invention may be modified, for example, in the following manner.

For example, the embodiments described above presuppose a construction vehicle tire used in a dump truck, an articulate dump truck, or a wheel loader that travels on crushed stones, or in a mine or a dam construction site, however the scope of application of the present invention is not necessarily limited to such a construction vehicle tire. For example, the present invention may be applied to a construction vehicle tire used in a construction vehicle other than a dump truck that travels in a construction site, or on uneven ground or muddy ground.

Further, the number of the belt layers 20 or the like is one example, and therefore a configuration of the belt layer 20 may be modified as needed in accordance with usage of the construction vehicle tire.

In this way, it is obvious that the present invention includes various embodiments not described herein. Accordingly, the scope of the present invention is defined only by technical features described in Claims reasonable based on the above-description.

The entire contents of Japanese Patent Application No. 2015-196705 (filed on Oct. 2, 2015) and Japanese Patent Application No. 2016-185614 (filed on Sep. 23, 2016) are incorporated herein by reference.

### INDUSTRIAL APPLICABILITY

According to the features of the present invention, a construction vehicle tire capable of reducing compression strain generated in a carcass folded portion even in a state closer to an actual use environment in which large lateral force is input, and capable of improving durability of a bead portion, can be provided.

### REFERENCE SIGNS LIST

1, 1A: construction vehicle tire
10: tread portion
15: side wall portion
20: belt layer
30: carcass layer
31: carcass cord
40: carcass body portion
50: carcass folded portion
51: end portion
60: bead portion
61: bead core
100: wheel rim
110: rim flange

1. A construction vehicle tire comprising:
a carcass body portion formed by a covered carcass cord; and
a carcass folded portion continued to the carcass body portion and folded at a bead core from an inner side in a tire width direction toward an outer side in the tire width direction, the carcass folded portion being formed by a covered carcass cord,
wherein:
a distance between cords, which is defined by a distance between the carcass cord of the carcass body portion and the carcass cord of the carcass folded portion, becomes smaller from the bead core toward an outer side in a tire radial direction to a minimum value a, and after the distance between the cords become the minimum value a, the distance between the cords becomes larger toward the outer side in the tire radial direction to the maximum value b; and
when the construction vehicle tire is mounted to an applicable rim, a height HA of the carcass cord of the carcass body portion corresponding to the minimum value a from a base line of the applicable rim, a height HB of the carcass cord of the carcass body portion corresponding to the maximum value b from the base line of the applicable rim, and a flange height HF of the applicable rim from the base line of the applicable rim fulfill relations of
1.2HF≤HA≤2.5HF
2.6HF≤HB≤3.5HF
1.10≤b/a<1.40.

2. The construction vehicle tire according to claim 1, wherein a height CH of a carcass line of a tread portion of the construction vehicle tire from the base line of the applicable rim and a height PE of an end portion of the carcass folded portion from the base line of the applicable rim fulfill a relation of
0.50≤PE/CH≤0.58.

3. The construction vehicle tire according to claim 1, wherein a crossing angle θ between a straight line SL1 passing a position of the carcass cord of the carcass body portion corresponding to the minimum value a and a position of the carcass cord of the carcass body portion corresponding to the maximum value b, and a straight line SL2 passing a position of the carcass cord of the carcass folded portion corresponding to the minimum value a and a position of the carcass cord of the carcass folded portion corresponding to the maximum value b fulfill a relation of
2.00°≤θ≤5.00°.

4. The construction vehicle tire according to claim 1, wherein the number of the portions of the maximum value b is only one between the bead core and the end portion at the outer side in the tire radial direction of the carcass folded portion.
